(19) United States
(12) Patent Application Publication
(10) Pub. No.: US 2009/0257725 A1
(43) Pub. Date: Oct. 15, 2009

(54) Preform for an optical fibre

(76) Inventors: Geoffrey Burton Smith, Epping (AU); James Bruce Franklin, Camperdown (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/547,409

(22) PCT Filed: Apr. 1, 2005
(86) PCT No.: PCT/AU2005/000471

§ 371 Date: Mar. 12, 2008

(30) Foreign Application Priority Data
Apr. 2, 2004 (AU) 2004901780

(51) Int. Cl. G02B 6/02; C03B 37/075

(52) U.S. Cl. 385/123; 65/393; 65/494

(57) ABSTRACT

The present invention provides a method of fabricating a preform (10) for a microstructured optical fibre. The method includes providing at least one hole forming element (13) in a mold. Each hole forming element (13) is elongate and is composed of a polymeric material that stretches and reduces in thickness upon application of a tensile stress (such as a nylon line). The method also includes forming the preform material (12) around, and contiguous, with an external surface portion of each hole forming element (13). The method further includes applying a tensile stress to a portion (14) of each hole forming element (13) to locally thin a zone (18) of each hole forming element (13), the thinning resulting in local detachment of the zone (18) from the preform material (10). A length of the detached zone (18) increases while the tensile stress is applied leaving a tubular portion in the preform material (12) where the hole forming element (13) was attached.

### FIELD OF THE INVENTION

The present invention broadly relates to preform for an optical fibre and relates particularly, though not exclusively, to a preform for a micro-structured polymer optical fibre. Throughout the specification the term “optical fibre” is used for any optical cable or optical fibre including optical light guides for medical applications, such as endoscopes, and optical fibres for photonic applications.

### BACKGROUND OF THE INVENTION

Micro-structured polymer optical fibres are of interest for a range of different photonic applications. Polymer optical fibres for photonic applications are considered to be relatively easy to install and are of particular interest for local area networks in which signal attenuation is of less significance.

Micro-structured polymer optical fibres include so-called “holey” fibres such as fibres having an arrangement of hollow tubular portions in or around the light guiding area of the fibre. For example, the hollow tubular portions may be arranged so that a photonic crystal fibre is formed. In this case light may be guided in a solid core of the waveguide surrounded by the tubular hollow portions in a particular geometric arrangement which results in formation of a photonic band-gap. Alternatively, the hollow tubular portions may be arranged so that no photonic band-gap is formed and light is guided in the core region of the fibre because the surrounding region is of lower refractive index.

In an alternative application micro-structured polymer optic fibres are of interest for potential medical applications such as for a light guiding medium for an endoscope. For example, an optical fibre for an endoscope, which may be of much larger thickness than an optical fibre for a photonic application, would comprise a number of hollow tubular portions which are arranged to guide light by internal reflection so that each hollow tubular portion corresponds to a pixel of an image that is transferred by the optical fibre. Alternatively, regions of the optical fibre between the hollow tubular portions may be used to guide the light.

Micro-structured polymer optical fibres are usually drawn from a preform. Preparation of such a preform is often a challenge and preform preparation techniques available to date limit the quantity and quality of the optical fibres that are drawn from the preform. For example, a preform for micro-structured polymer fibres for photonic applications should have a large number of narrow hollow tubular portions. Ideally, the preform should be of relatively long length, such as one metre. The fabrication of a preform having such a large number of small and long holes is extremely challenging.

The quality of images that are achievable with an endoscope having a micro-structure polymer fibre is limited by the number of hollow tubular portions in the fibre and preparation of a preform with the required large number of such long and hollow tubular portions, such as a few hundred or a few thousand, is very difficult. Further, the light guiding properties of such an endoscope fibre over useful lengths are particularly good if the distance between at least a large number of adjacent tubular hollow portions is relatively small, such as only 10-15% of the diameter of the hollow portions. The fabrication of a preform for such fibres having a large number of closely spaced hollow portions is particularly difficult. While very small errors in the positions and/or variations in diameter of the hollow portions may be tolerated and may actually improve optical performance, the close proximity of the hollow portions requires small tolerances of their positions, such as less than 10-15% of their diameter if adjacent hollow portions are spaced apart by that distance. Considering that ideally this needs to be achieved for a preform having a few thousand hollow portions, the difficulty becomes apparent. Similar considerations apply to the construction of preforms for micro-structured polymer fibres for photonic applications.

Polymeric preforms having hollow tubular portions have been prepared by mechanically drilling holes into the preform material. However, the number of hollow tubular portions and their length that may be achieved by this mechanical procedure is limited. These restrictions on the maximum number of holes in a preform and on the maximum length of a preform are impediments to commercialising micro-structured polymer optical fibres. Another problem is that the drilling process is very slow (particularly for small diameter closely spaced holes) and hence is expensive. Also, the drilling process usually requires the use of a lubricant that may contaminate the preform and result in reduced fibre quality. An additional problem is that the locally high stresses associated with the drilling process may cause structural changes at the interior surface of the hollow tubular portions which may result, for example, in optical scattering losses and therefore in reduced fibre quality. Further, the drilling process is essentially limited to the production of hollow tubular portions of circular-cross section whereas other cross-sectional shapes are advantageous for some types of micro-structured optical fibres.

Preforms for polymer optical fibres having a relatively low number of hollow tubular portions have also been prepared by forming the preform around steel wires and pulling the steel wires out of the preform once the polymeric material has formed. Unfortunately, the polymeric material shrinks during its formation which makes it very difficult to pull the steel wires out of the preform. With this method it is therefore often not possible to prepare preforms having hollow tubular portions that are sufficiently thin and long.

One somewhat improved solution involves the usage of electrically resistive wires for the formation of the hollow tubular portions. After the polymeric material has formed around the resistive wires, an electrical current is directed through the resistive wires so as to heat the resistive wires. The resistive wires locally melt the polymeric material so that they can be pulled out. However, this is a rather complicated method. A disadvantage of this method is that, as discussed above, some designs of micro-structured optical fibres require that the distance between adjacent holes is small compared with the diameter of the holes (a ratio of less than 10%-15% is common in high performance designs). However melting of the polymer in order to extract the wire hole forming element inherently requires that there is a mechanically robust unmelted portion of polymer between adjacent wires. If the solid zone between the wires is of insufficient strength (due to thinness and/or partial melting) then melting the polymer around the wires and extracting the wires will lead to permanent deformation of the zone. In extreme cases it may even lead to the zone being pulled out of the preform. Another problem is that the local melting of the polymeric material and the pulling of the resistive wires results in structural changes at the interior surface.

The degree of structural change and the depth of the modified zone may vary along a hollow tubular portion with the portion closest to the wire extraction end likely to experience the greatest change in optical properties from those of the bulk material. If the wires are too closely spaced then thermal interactions between adjacent wires and/or hollow tubular portions may give rise to variations in the optical properties of the material around the circumference of a hollow tubular portion. A lack of homogeneity of the polymer may result in optical scattering losses and therefore in reduced fibre quality.

There is a need for an alternative technical solution.

### SUMMARY OF THE INVENTION

The present invention provides in a first aspect a method of fabricating a preform for an optical fibre, comprising:

providing at least one hole forming element, the or each hole forming element being elongate and being composed of a material that reduces in thickness and stretches upon application of a tensile stress,

forming a preform material around, and contiguous with, an external surface portion of the or each hole forming element and

applying a tensile stress to a portion of the or each hole forming element to locally thin a zone of the or each hole forming element in a manner such that the thinning results in local detachment of the or each zone from the preform material,

wherein the length of the or each detached zone increases while the tensile stress is applied leaving a tubular portion in the preform material where the or each hole forming element was attached.

The preform material typically is a polymeric material.

This method has significant advantages. Because the or each zone of the or each hole forming element is locally stretched and thinned, the detachment of the hole forming element from the polymeric material is a sequential process. The hole forming element may not have to be as strong as for a fabrication method in which the detachment process is not a sequential process. Consequently it is possible to produce relatively long preforms having long and relatively thin hollow tubular portions.

As the detachment is caused by a reduction of the thickness of the or each hole forming element, the inner surface portion of the preform material that surrounds the or each formed tubular portions is largely unaffected by the detachment process.

In one specific embodiment, the or each hole forming element has a segment that projects from a face of the preform material that surrounds the portion of the or each hole forming element. If a suitable tensile stress is applied to the or each hole forming element at the face of the preform, for example by pulling the portion, the zone at the face of the preform typically is stretched and thinned which results in a local detachment from the preform material. The detachment continues in a direction into the preform material as long as the suitable tensile stress is applied and until the or each hole forming element is detached from the preform material.

The method typically comprises the step of arranging a plurality of the hole forming elements in a predetermined manner prior to forming the preform material around the or each portion of the at least one hole forming element.

The or each hole forming element typically is composed of a polymeric material, such as nylon. For example, the or each hole forming element may be a nylon line. The nylon line may be stretched and thinned after its fabrication and before embedding the or each nylon line into the preform material. Alternatively, the nylon line is not stretched and thinned after its fabrication and before forming the preform material around the or each nylon line.

The or each hole forming element typically has a Young's modulus that is lower than that of the preform material. The or each hole forming element may also have a Young's modulus that increases during the application of the tensile stress.

If the preform material is polymeric, the or each hole forming element typically is of a material that is compatible with the monomer of the preform polymer. For example, the monomer typically does not affect the structure, stability or shape of the or each hole forming element.

The or each hole forming element typically is solid. Alternatively, the or each hole forming element may be hollow. In this case the application of the tensile stress to the or each hole forming element may result in an at least partial collapse of the hollow interior space when the or each hole forming element is stretched.

The or each hole forming element may have a smooth surface which tends to be easier to detach from the preform material than a rough surface. The or each hole forming element typically has a circular cross-sectional shape but may alternatively have any non-circular cross-sectional shape. For example, the or each hole forming element may have a diameter of 0.1 to 2.0 mm. Alternatively, the or each hole forming element may also have a diameter that is smaller than 0.1 mm or larger than 2.0 mm. A plurality of such hole forming elements such as more than one hundred or more than one thousand, typically are arranged so that at least a majority of adjacent hole forming portions are separated by a distance of less than 50%, 40%, 30%, 20% or 10% of their diameter.

Typically the cross-sectional shape of the or each hole forming element is substantially constant along its length. Alternatively, the cross-sectional shape of the or each hole forming element may vary along part or all of its length. Typically the orientation of the or each hole forming element does not change along its length. Alternatively, the orientation of the or each hole forming element may change along part or all of its length. For example, a non-circular hole forming element may have a longitudinal twist. In another example, a plurality of hole forming elements are mutually twisted around a common longitudinal axis.

The or each hole forming element may comprise a core portion and a core surrounding portion. The or each core portion and the or each core surrounding portion typically are detachable from each other. For example, the or each core surrounding portion may be a tubular portion in which the or each core portion is positioned and from which the or each core portion can be removed.

In one specific example, the or each core surrounding portion is a coating of the or each core portion. If the or each core portion and the or each core surrounding portion are detachable form each other, the step of applying a tensile stress to a portion of the or each hole forming element typically comprises applying the tensile stress to the or each core portion so that the or each core portion detaches from the or each core surrounding portion. In this case the or each core surrounding portion typically forms a portion of the formed preform. The core surrounding portion may comprise a material having a different refractive index than the preform material that surrounds the core surrounding portion in the formed preform. Typically the refractive index of the core surrounding portion is less than the preform material that surrounds the core surrounding portion in the formed preform. The core surrounding portion may act a spacer for closely spaced hole forming elements which may be advantageous in creation of closely spaced holes in the preform.

The method may also comprise the step of coating and/or filling at least one hollow tubular portion with another material or materials such as a material that has a refractive index different to that of the material surrounding the or each tubular portions. Typically the refractive index of the material that fills the or each hollow tubular portion is chosen so that it is higher than that of the surrounding material. In one embodiment each filled tubular portion may function similar to a conventional optical fibre having a central portion composed of a material that has a refractive index higher than that of the surrounding region.

The step of applying a tensile stress may be conducted so that the tensile stress is applied to each of a plurality of the hole forming elements in sequence. Alternatively, the tensile stress may be applied simultaneously to more than one hole forming element.

In one specific embodiment, the or each hole forming element has an end-portion at either or both ends which has a cross-sectional area that is smaller than the average cross-sectional area of said hole forming element. The or each end-portion having such reduced cross-sectional area facilitates mounting of closely spaced hole forming elements and is particularly advantageous when fabricating a preform in which the distance between adjacent holes is less than one third of the hole diameter. Additionally, if such an end-portion extends into a mould area into which the material for formation of the preform is inserted, then that part of the mould area is relatively open which facilitates the filling of the mould area with the material.

In one specific embodiment a plurality of hole forming elements are provided and all hole forming elements have substantially the same diameter. Alternatively, the hole forming elements may have a number of different diameters.

The present invention provides in a second aspect a preform made by the above-defined method.

The present invention provides in a third aspect

a preform composed of a preform material and comprising a plurality of tubular portions, wherein the structure of the preform material at interior boundaries of the tubular portions is substantially the same as that of the preform material remote from the boundaries.

The preform material typically is polymeric. The composition of the polymeric material at the interior boundaries of the tubular portions typically is substantially the same as that of polymeric material remote from the boundaries. The tubular portions are typically hollow. Alternatively, the tubular portions may comprise another material such a material having a refractive index different to that of the material surrounding the tubular portions. Typically the refractive index of the other material is lower than that of the material surrounding the tubular portions. The other material typically is a polymeric material.

The present invention provides in a fourth aspect a

method of fabricating a preform for an optical fibre, comprising:

providing at least one hole forming element, the or each hole forming element being elongate and comprising a core portion and a core surrounding portion which are detachable from each other,

forming a preform material around, and contiguous with, an external surface portion of the or each core surrounding portion and thereafter

removing the or each core portion.

The present invention provides in a fifth aspect an optical fibre drawn using the above-defined preform.

The present invention provides in a sixth aspect a device for fabricating a preform for an optical fibre, the device comprising:

a plurality of hole forming elements, each hole forming element being elongate and being composed of a material that reduces in thickness and stretches upon application of a tensile stress,

a container for receiving a material that forms the preform and

a holder for holding the hole forming elements at spaced apart positions in the container.

Each hole forming element typically has a neck of reduced cross-sectional area and the holder typically holds each hole forming element at the neck of reduced cross-sectional area.

The invention will be more fully understood from the following description of specific embodiments of the invention. The description is provided with reference to the accompanying drawings.

### BRIEF DESCRIPTION OF THE DRAWINGS

FIG. 1 shows a schematic illustration of a method of fabricating a preform for an optical fibre according to a specific embodiment of the present invention,

FIG. 2 shows a further schematic illustration of a method of fabricating a preform for an optical fibre according to a specific embodiment of the present invention,

FIG. 3 shows a hole forming element according to an embodiment of the present invention,

FIG. 4 shows a preform for an optical fibre for an endoscope according to a specific embodiment of the present invention, and

FIG. 5 shows a preform for an optical fibre for a photonic application according to another specific embodiment of the present invention.

### DETAILED DESCRIPTION OF SPECIFIC EMBODIMENTS

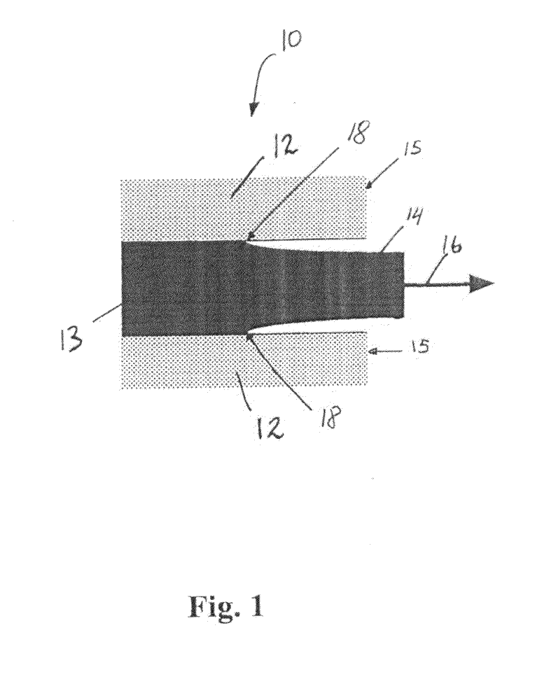

Referring initially to FIG. 1, a method of fabricating a preform for an optical fibre is now described. FIG. 1 shows a portion of a preform 10, which in this embodiment composed of a polymeric material 12. In this embodiment the preform 10 is of a generally circular cross-sectional shape. For the fabrication of the preform 10 a plurality of hole forming elements, such as nylon lines 13 (FIG. 1 shows only one of the nylon lines 13), are arranged in a predetermined manner. In this case the nylon lines 13 are arranged so that they are parallel to each other and form an array. Typically one step in the manufacture of nylon line is to apply a large enough tensile force to cause considerable elongation and plastic deformation. This drawn line tends to be less suitable as an hole forming element than undrawn or partially drawn nylon line.

A polymeric material is then cast around length portions of each nylon lines 13 so that the polymeric material surrounds the length portions of the nylon lines 13.

In this embodiment, the nylon line 13 has a lower Young's modulus than that of the polymeric material of the preform 12. If a cylinder of low stiffness material is embedded in a matrix of higher Young's modulus and subject to a tensile stress from one end, then most of the load is taken by the portion of the cylinder closest to the load.

After the polymeric material 12 has hardened, the free end of each nylon line 13 is pulled in a direction away from face 15 of the polymeric material as indicated by arrow 16. This results in a tensile stress in the free portions 14 of the nylon line 13 and at area 18 which stretches the free portion 14 and the embedded nylon line at area 18 so that the thickness is locally reduced. The reduction of thickness at area 18 results in a local detachment of the nylon line 13 at area 18. The continuing application of a tensile stress results in a sequential detachment of the nylon line 13 from the polymeric material 12 until the line 13 can be removed from the preform.

It will be appreciated by those skilled in the art that it is desirable that the Young's modulus of the nylon line 13 increases as the nylon material is stretched and thinned and therefore necked down at area 18.

In a variation of the embodiment shown in FIG. 1, the nylon lines 13 may be at least partially hollow in which case the application of the tensile stress results in at least a partial collapse of the hollow space in each nylon line 13.

Because the detachment of the nylon lines 13 from the polymeric material 12 happens sequentially, the detachment requires relatively little force. Therefore, the nylon 13 can be relatively thin and relatively long hollow tubular portions can be formed. For example, the nylon line 13 may have a thickness of 0.1 to 2.0 mm or smaller than 0.1 mm and the formed hollow tubular portions may have a length in the order of 1 metre.

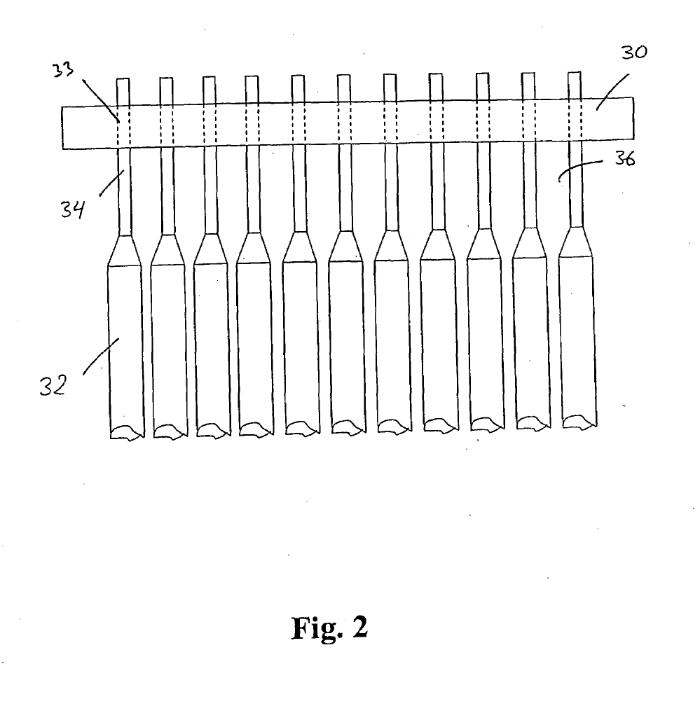

FIG. 2 shows a diagram illustrating a method step according to a specific embodiment of the present invention. FIG. 2 shows side views of a plate 30 and a plurality of hole forming elements which in this embodiment are nylon lines 32. The plate 30 has a plurality of holes 33 through which end-portions 34 of the nylon lines 32 are inserted and by which the nylon lines 32 are located in a moulding area 36. The moulding area 36 is surrounded by a cylindrical wall portion which is not shown in FIG. 2. Each end-portion 34 is of reduced cross-sectional area compared with that of other portions of the nylon lines. The relatively thin end-portions 34 facilitate mounting of closely spaced nylon lines 32 and are particularly advantageous when fabricating a preform in which the distance between adjacent holes is less than one third of the hole diameter. In this embodiment, the thin end-portions 34 extend through the holes of the plate 30 and into the mould area 36. This has the advantage that the upper portion of the mold area 36 is relatively open which facilitates the removal of unwanted gases from the mould and the filling of the mould area 36 with the molding material through the upper portion. In this embodiment the end-portions 34 are thinned by drawing end-portions of undrawn nylon lines.

In one variation of the embodiment shown in FIG. 2, the hole forming elements 32 are of non-circular cross-section and their axial orientation is controlled by the plate 30. In another variation the hole forming element 32 has a longitudinal twist. In a further variation, a plurality of hole forming elements 32 are twisted about a longitudinal axis.

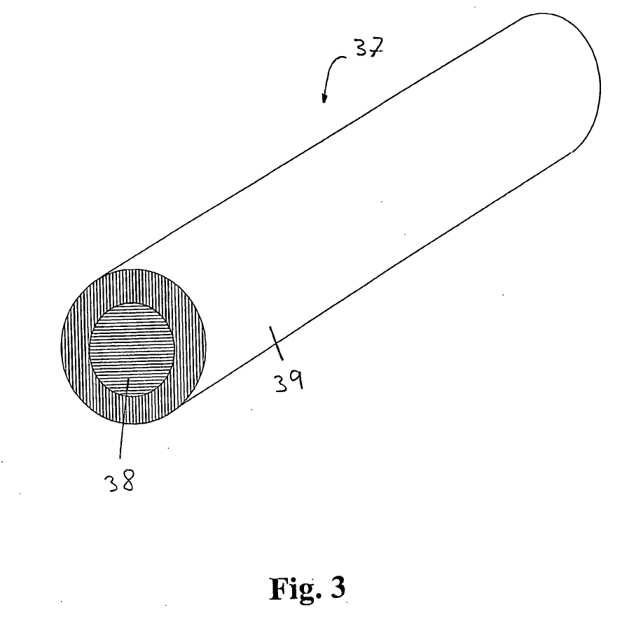

FIG. 3 shows a hole forming element according to an embodiment of the present invention. The hole forming element 37 comprises a core portion 38 and a core surrounding portion 39. The core surrounding portion 39 is detachable from the core portion 38. For fabrication of a preform using such hole forming elements, a plurality of the hole forming elements 37 is positioned in a mould. Preform material is then formed around the core surrounding portions 39 so that the formed preform material adheres to the core surrounding portion 39. The core portions 38 are then removed.

In this embodiment the core surrounding portion 39 is a coating of PMMA on the core portion 38 which is composed of nylon. However, it will be appreciated that in an alternative embodiment the core portion and the core surrounding portions 39 may also be formed from another suitable material. Typically the material of the core surrounding portion 39 has a refractive index that is lower that that of the preform material.

The core portion 38 typically is composed of a material that stretches and thins upon application of a tensile stress and the detachment process from the core surrounding portion typically is a sequential process. In one specific variation, however, the core portion is be composed of a relatively strong material, such as steel or the like, and the core surrounding portion is a tubular portion composed of or coated with material that allows removal of the core portion with relatively little friction. For example, the core surrounding portion may comprise Teflon at least at its inner surface.

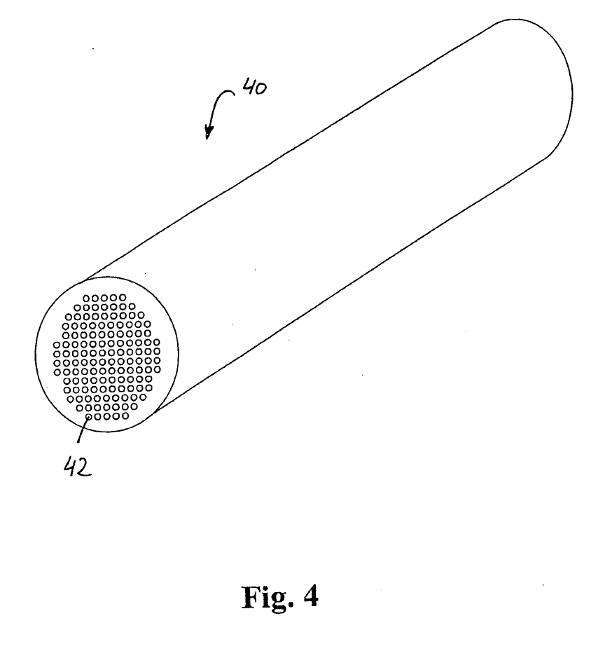

FIG. 4 shows a preform 40 for an optical fibre for an endoscope. The preform 40 comprises an array of hollow tubular portions 42. The preform 40 is formed from a polymeric material and each tubular hollow portion 42 is formed by the process described above and illustrated in FIGS. 1 and 2. An optical fibre may be drawn from the preform 40 using a conventional process and the optical fibre will have the same arrangement of tubular hollow portions and shape as the preform 40.

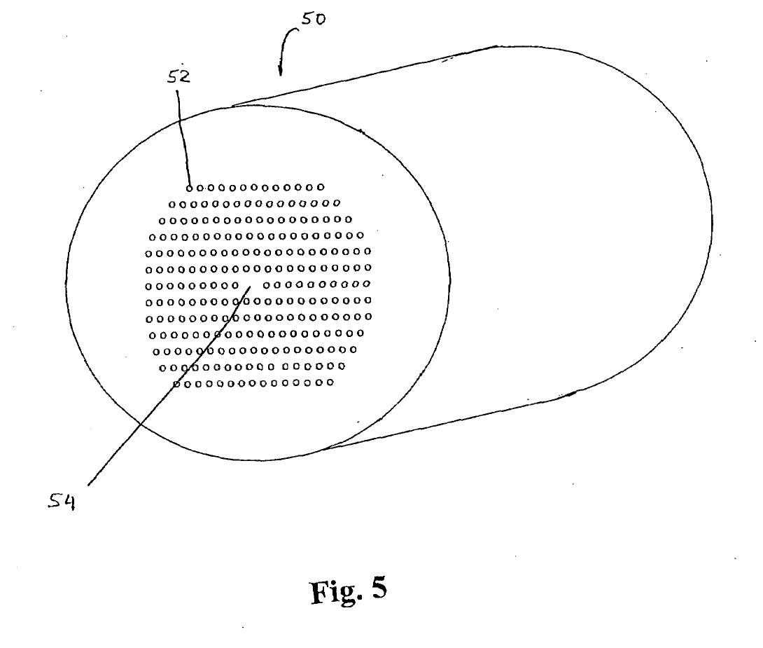

FIG. 5 shows a preform 50 for an optical fibre for photonic applications. The preform 50 is composed of a polymeric material and comprises an array of hollow tubular portions 52 each of which is formed by the process described above and illustrated in FIGS. 1 and 2. An optical fibre may be drawn from the preform 50 using a conventional process and the optical fibre will have the same arrangement of tubular hollow portions and shape as the preform 50. In this embodiment the preform 50 has a solid core region 54 and the hollow tubular portions 52 are arranged so the in the drawn optical fibre light is guided in the solid core region.

Although the invention has been described with reference to particular examples, it will be appreciated by those skilled in the art that the invention may be embodied in many other forms. For example, it will be appreciated that the hole forming elements, such as the nylon lines 13, may comprise any suitable material that stretches and reduces in thickness when a tensile stress is applied to the material and when the hole forming elements are at least in part embedded in the polymeric material of the preform.

In the described embodiments the tubular hollow portions have a circular cross-sectional shape. It will be appreciated that the tubular hollow sections may alternatively have any other suitable cross-sectional shape such as square, triangular or oval and the hole forming elements will have corresponding shapes. Further, the hollow tubular portions may form any other arrangement suitable to guide light.

In addition, the hollow tubular portions may be filled with another material such as a material having a refractive index different to that of the material surrounding the tubular portions. Typically the refractive index of the filled hollow portion may be chosen so that it is lower than that of the surrounding polymeric material.

It will also be appreciated that the preform may be used to draw optical fibres for applications outside the photonic or medical area. Further, it will be appreciated that the preform may not comprise a polymeric material but may alternatively comprise a suitable glass.

1. A method of fabricating a preform for an optical fibre, comprising:
providing at least one hole forming element, the or each hole forming element being elongate and being composed of a material that reduces in thickness and stretches upon application of a tensile stress,
forming a preform material around, and contiguous with, an external surface portion of the or each hole forming element and
applying a tensile stress to a portion of the or each hole forming element to locally thin a zone of the or each hole forming element in a manner such that the thinning results in local detachment of the or each zone from the preform material,
wherein the length of the or each detached zone increases while the tensile stress is applied leaving a tubular portion in the preform material where the or each hole forming element was attached.

2. The method as claimed in claim 1 wherein the preform material is a polymeric material.

3. The method as claimed in claim 1 wherein the or each hole forming element has a segment that projects from a face of the preform material which surrounds the portion of the or each hole forming element.

4. The method as claimed in claim 1 comprising the step of arranging a plurality of the hole forming elements in a predetermined manner prior to forming the preform material around the or each portion of the or each hole forming element.

5. The method as claimed in claim 1 wherein the or each hole forming element is composed of a polymeric material.

6. The method as claimed in claim 1 wherein the or each hole forming element has a Young's modulus that is lower that of the preform material.

7. The method as claimed in claim 1 wherein a Young's modulus of the or each hole forming element increases during the application of the tensile stress.

8. The method as claimed in claim 1 wherein the or each hole forming element is a nylon line.

9. The method as claimed in claim 8 wherein the nylon line is stretched and thinned after its fabrication and before forming the preform material around the or each nylon line.

10. The method as claimed in claim 8 wherein the nylon line is not stretched and thinned after its fabrication and before forming the preform material around the or each nylon line.

11. The method as claimed in claim 1 wherein the or each hole forming element is solid.

12. The method as claimed in claim 1 wherein the or each hole forming element is hollow.

13. The method as claimed in claim 12 wherein the application of the tensile stress to the or each hole forming element results in an at least partial collapse of the hollow interior space when the or each hole forming element is stretched.

14. The method as claimed in claim 1 wherein the or each hole forming element has a circular cross-sectional shape.

15. The method as claimed in claim 1 wherein the or each hole forming element has a non-circular cross-sectional shape.

16. The method as claimed in claim 1 wherein the or each hole forming element has a diameter of 0.1 to 2.0 mm.

17. The method as claimed in claim 1 wherein the or each hole forming element has a diameter of less than 0.1 mm.

18. The method as claimed in claim 1 wherein the or each hole forming element has a diameter of more than 2.0 mm.

19. The method as claimed in claim 1 wherein the preform is formed using a plurality of hole forming elements arranged so that at least a majority of adjacent hole forming portions are separated by a distance of less than 40% of their diameter.

20. The method as claimed in claim 1 wherein the preform is formed using a plurality of hole forming elements arranged so that at least a majority of adjacent hole forming portions are separated by a distance of less than 20% of their diameter.

21. The method as claimed in claim 1 wherein the preform is formed using a plurality of hole forming elements arranged so that at least a majority of adjacent hole forming portions are separated by a distance of less than 10% of their diameter.

22. The method as claimed in claim 1 wherein the or each hole forming element comprises a core portion and a core surrounding portion.

23. The method as claimed in claim 22 wherein the or each core portion and the or each core surrounding portion are detachable from each other.

24. The method as claimed in claim 22 wherein the or each core surrounding portion is a coating of the or each core portion.

25. The method as claimed in claim 23 wherein the step of applying a tensile stress to a portion of the or each hole forming element comprises applying the tensile stress to the or each core portion so that the or each core portion detaches from the or each core surrounding portion.

26. The method as claimed in claim 1 wherein the preform is formed having more than one hundred tubular hollow portions.

27. The method as claimed in claim 1 wherein the preform is formed having more than one thousand tubular hollow portions.

28. The method as claimed in claim 1 wherein a plurality of the hole forming elements are provided and the step of applying the tensile stress is conducted so that the tensile stress is applied in sequence to each of a plurality of the hole forming elements.

29. The method as claimed in claim 1 wherein a plurality of the hole forming elements are provided and the tensile stress is applied simultaneously to more than one hole forming element.

30. The method as claimed in claim 1 comprising the step of coating at least one hollow tubular portion with a material that has a refractive index different to that of the preform material surrounding the or each tubular portion.

31. The method as claimed in claim 1 comprising the step of filling at least one hollow tubular portion with a material that has a refractive index different to that of the preform material surrounding the or each tubular portion.

32. The method as claimed in claim 30 wherein the material has a refractive index that is lower than that of the preform material surrounding the tubular portions.

33. The method as claimed in claim 1 wherein the or each hole forming element has an end-portion which has a cross-sectional area that is smaller than the average cross-sectional area of said hole forming element.

34. The method as claimed in claim 33 wherein the or each end-portion of smaller cross-sectional area extends into a mould area into which the material for formation of the preform is inserted.

35. A preform fabricated by the method as claimed in claim 1.

36. A preform composed of a preform material and comprising a plurality of tubular portions, the tubular portions being formed by detaching hole forming elements from the preform material, wherein inner surface portions of the preform material that surrounds the or each formed tubular portion are unaffected by the detachment process.

37. The preform as claimed in claim 36 wherein the preform material is a polymeric material.

38. The preform as claimed in claim 37 wherein the composition of the polymeric material at the interior boundaries of the tubular portions is substantially the same as that of polymeric material remote from the boundaries.

39. The preform as claimed in claim 36 wherein the tubular portions are hollow.

40. The preform as claimed in claim 36 wherein the tubular portions comprise a polymeric material having a refractive different to that of the material surrounding the tubular portions.

41. The preform as claimed in claim 40 wherein the tubular portions comprise a polymeric material having a refractive index lower than that of the material surrounding the tubular portions.

42. A device for fabricating a preform for an optical fibre, the device comprising:
a plurality of hole forming elements, each hole forming element being elongate and being composed of a material that reduces in thickness and stretches upon application of a tensile stress,
a container for receiving a material that forms the preform and
a holder for holding the hole forming elements at spaced apart positions in the container.

43. The device as claimed in claim 42 wherein each hole forming element has a neck of reduced cross-sectional area and the holder holds each hole forming element at the neck of reduced cross-sectional area.
